(19) United States
(12) Patent Application Publication
(10) Pub. No.: US 2025/0157731 A1
(43) Pub. Date: May 15, 2025

(54) MULTILAYER CERAMIC CAPACITOR

(71) Applicant: Murata Manufacturing Co., Ltd., Nagaokakyo-shi (JP)

(72) Inventors: Yoko WAKAIZUMI, Nagaokakyo-shi (JP); Masaaki SUGIYAMA, Nagaokakyo-shi (JP)

(21) Appl. No.: 18/904,138

(22) Filed: Oct. 2, 2024

(30) Foreign Application Priority Data
Nov. 10, 2023 (JP) 2023-192281

(51) Int. Cl. H01G 4/012; H01G 4/008; H01G 4/232; H01G 4/30

(52) U.S. Cl. CPC H01G 4/012; H01G 4/0085; H01G 4/30; H01G 4/2325

(57) ABSTRACT

A multilayer ceramic capacitor includes an element body portion including dielectric layers and internal electrode layers stacked in a thickness direction, a first external electrode on a first end surface of the element body portion, and a second external electrode on a second end surface of the element body portion. The internal electrode layers include first internal electrode layers connected to the first external electrode, and second internal electrode layers connected to the second external electrode. Each of the internal electrode layers includes an opposing portion opposed, in the thickness direction, to an adjacent internal electrode layer. A third internal electrode layer is located in a space between the opposing portion and at least one of first and second side surfaces, in a width direction.

### CROSS REFERENCE TO RELATED APPLICATIONS

This application claims the benefit of priority to Japanese Patent Application No. 2023-192281, filed on Nov. 10, 2023, the entire contents of which are hereby incorporated herein by reference.

### BACKGROUND OF THE INVENTION

### 1. Field of the Invention

The present disclosure relates to multilayer ceramic capacitors.

### 2. Description of the Related Art

As a conventional multilayer ceramic capacitor, Japanese Patent Laid-Open No. 2009-32934 discloses a multilayer ceramic capacitor including a multilayer body in which a plurality of dielectric layers and a plurality of internal electrode layers are stacked alternately, with an external electrode disposed on each of the opposite end surfaces of the multilayer body. A side margin portion is formed between each of the opposite side surfaces of the multilayer body and the internal electrode layer, and an end margin portion is formed between each of the opposite end surfaces of the multilayer body and an opposing portion of an internal electrode layer opposing to an adjacent internal electrode layer.

However, no internal electrode layer is formed in the side margin portion, and no internal electrode layer is formed also in the end margin portion, except for a lead-out portion led out to the external electrode layer. Therefore, when moisture enters the multilayer body from the side margin portion and/or the end margin portion, the reliability of the multilayer ceramic capacitor may be significantly deteriorated.

### SUMMARY OF THE INVENTION

Example embodiments of the present invention provide multilayer ceramic capacitors each with improved reliability.

A multilayer ceramic capacitor according to an example embodiment of the present invention includes an element body portion including a first principal surface and a second principal surface opposite to each other in a thickness direction, a first side surface and a second side surface opposite to each other in a width direction, and a first end surface and a second end surface opposite to each other in a length direction, and including a plurality of dielectric layers and a plurality of internal electrode layers stacked in the thickness direction, a first external electrode on the first end surface, and a second external electrode on the second end surface. The plurality of internal electrode layers include a plurality of first internal electrode layers connected to the first external electrode, and a plurality of second internal electrode layers connected to the second external electrode. Each of the plurality of internal electrode layers includes an opposing portion opposed, in the thickness direction, to an adjacent internal electrode layer of the plurality of internal electrode layers. A third internal electrode layer is located in a space between the opposing portion and at least one of the first side surface and the second side surface, in the width direction.

In a multilayer ceramic capacitor according to an example embodiment of the present invention, a fourth internal electrode layer may be located in at least one of a space between the first internal electrode layer and the second end surface, and a space between the second internal electrode layer and the first end surface, in the length direction.

In a multilayer ceramic capacitor according to an example embodiment of the present invention, the fourth internal electrode layer located in the space between the first internal electrode layer and the second end surface in the length direction may be located at a same or substantially a same position in the thickness direction as the first internal electrode layer. The third internal electrode layer located in the space between the second internal electrode layer and the first end surface in the length direction may be located at a same or substantially a same position in the thickness direction as the second internal electrode layer.

In a multilayer ceramic capacitor according to an example embodiment of the present invention, Ni may be diffused in a peripheral region of the fourth internal electrode layer, the peripheral region excluding a region extending from the fourth internal electrode layer by about one-third of a thickness of the fourth internal electrode layer.

In a multilayer ceramic capacitor according to an example embodiment of the present invention, a grain size in a peripheral region of the fourth internal electrode layer may be smaller than a grain size in a vicinity of an outermost surface of the element body portion.

In a multilayer ceramic capacitor according to an example embodiment of the present invention, Ni may be diffused in a peripheral region of the third internal electrode layer, the peripheral region excluding a region extending from the third internal electrode layer by about one-third of a thickness of the third internal electrode layer.

In a multilayer ceramic capacitor according to an example embodiment of the present invention, the third internal electrode layer may be located at a same or substantially a same position in the thickness direction as the opposing portion.

In a multilayer ceramic capacitor according to an example embodiment of the present invention, a grain size in a peripheral region of the third internal electrode layer may be smaller than a grain size in a vicinity of an outermost surface of the element body portion.

A multilayer ceramic capacitor according to an example embodiment of the present invention includes an element body portion including a first principal surface and a second principal surface opposite to each other in a thickness direction, a first side surface and a second side surface opposite to each other in a width direction, and a first end surface and a second end surface opposite to each other in a length direction, and including a plurality of dielectric layers and a plurality of internal electrode layers stacked in the thickness direction, a first external electrode on the first end surface, and a second external electrode on the second end surface. The plurality of internal electrode layers include a plurality of first internal electrode layers connected to the first external electrode, and a plurality of second internal electrode layers connected to the second external electrode. A fourth internal electrode layer is located in at least one of a space between the first internal electrode layer and the second end surface, and a space between the second internal electrode layer and the first end surface, in the length direction.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a cross-sectional view taken along line II-II shown in FIG. 1.

FIG. 3 is a cross-sectional view taken along line III-III shown in FIG. 1.

FIG. 4 is a flowchart showing a manufacturing flow for manufacturing a multilayer ceramic capacitor according to an example embodiment of the present invention.

### DETAILED DESCRIPTION OF THE EXAMPLE EMBODIMENTS

Hereinafter, example embodiments of the present invention are described in detail with reference to the drawings. In the following example embodiments, the same or common portions are denoted by the same reference characters in the drawings, and a description thereof is not repeated herein.

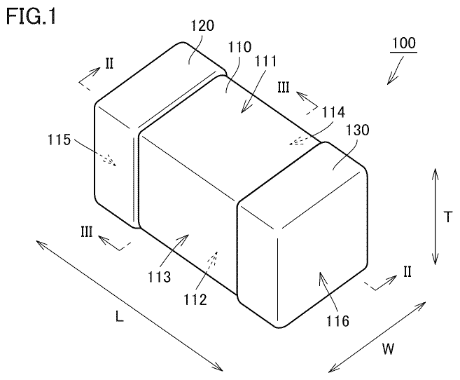

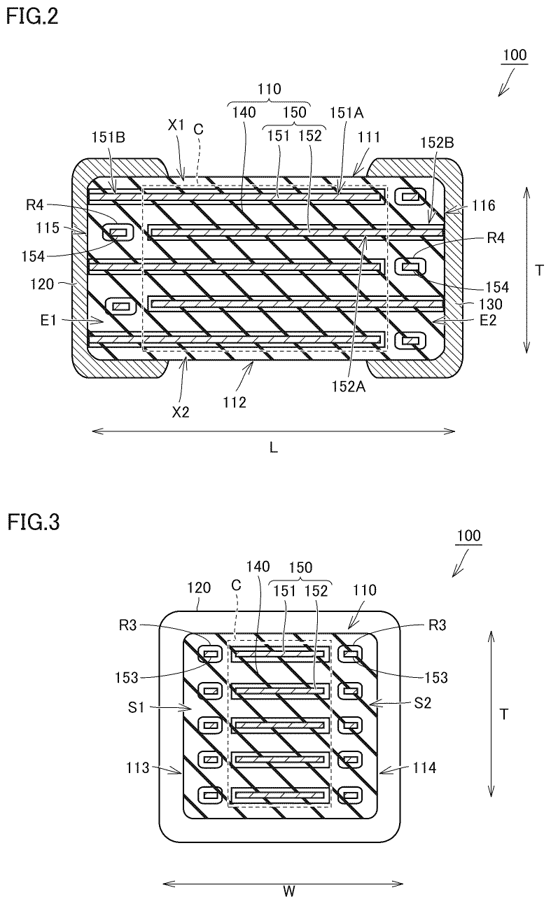

FIG. 1 is a perspective view of a multilayer ceramic capacitor according to an example embodiment of the present invention. FIG. 2 is a cross-sectional view taken along line II-II shown in FIG. 1. FIG. 3 is a cross-sectional view taken along line III-III shown in FIG. 1. A multilayer ceramic capacitor 100 according to an example embodiment is described with reference to FIGS. 1 to 3.

As shown in FIGS. 1 to 3, multilayer ceramic capacitor 100 according to the present example embodiment includes an element body portion 110, a first external electrode 120, and a second external electrode 130. Element body portion 110 is a multilayer body, and includes a plurality of dielectric layers 140 and a plurality of internal electrode layers 150 alternately stacked one by one along thickness direction T. In element body portion 110, a third internal electrode layer 153 and a fourth internal electrode layer 154 described later are provided.

The element body portion 110 has a rectangular or substantially rectangular parallelepiped shape. Element body portion 110 includes a first principal surface 111 and a second principal surface 112 that are opposite to each other in thickness direction T, a first side surface 113 and a second side surface 114 that are opposite to each other in width direction W intersecting thickness direction T, and a first end surface 115 and a second end surface 116 that are opposite to each other in length direction L intersecting thickness direction T and width direction W.

Element body portion 110 preferably includes rounded corners and ridges. The corner refers to a portion where three surfaces of element body portion 110 intersect, and the ridge refers to a portion where two surfaces of element body portion 110 intersect.

First external electrode 120 is provided on first end surface 115. Specifically, first external electrode 120 is provided on the entire or substantially the entire first end surface 115, and extends from first end surface 115 onto first principal surface 111, onto second principal surface 112, onto first side surface 113, and onto second side surface 114.

Second external electrode 130 is provided on second end surface 116. Specifically, second external electrode 130 is provided on the entire or substantially the entire second end surface 116, and extends from second end surface 116 onto first principal surface 111, onto second principal surface 112, onto first side surface 113, and onto second side surface 114.

First external electrode 120 and second external electrode 130 each include a base electrode layer and a plating layer provided on the base electrode layer. The base electrode layer includes at least one of, for example, a baked layer, a resin layer, a thin-film layer, and the like.

The baked layer includes, for example, glass and metal. The glass includes, for example, Si. The metal included in the baked layer is, for example, a metal including of Ni, Cu, Ag, Pd, and Au, or an alloy including this metal, and an alloy of, for example, Ag and Pd, or the like may be used as the alloy.

The baked layer is, for example, an electrically conductive paste including glass and metal that has been applied to element body portion 110 and baked, and the baked layer may be sintered simultaneously with internal electrode layer 150, or may be baked after internal electrode layer 150 is sintered.

The resin layer may include, for example, electrically conductive particles and a thermosetting resin. In forming the resin layer, the resin layer may be formed directly on the multilayer body without forming a baked electrode layer. The resin layer may include a plurality of resin layers.

The thin-film layer is formed by a thin-film deposition method such as, for example, sputtering method or vapor deposition method, and is a layer including deposited metal particles and having a thickness of, for example, about 1 μm or less.

The plating layer is made of, for example, a metal including Ni, Cu, Ag, Pd, and Au, or an alloy including this metal, and an alloy of, for example, Ag and Pd, or the like may be used as the alloy.

The plating layer may include a plurality of plating layers. The plating layer has, for example, a two-layer structure of an Ni plating layer and an Sn plating layer. The Ni plating layer can prevent the base electrode layer from being eroded by solder used for mounting the multilayer ceramic capacitor. The Sn plating layer improves the wettability of solder used for mounting the multilayer ceramic capacitor, which makes it easy to mount the multilayer ceramic capacitor.

First external electrode 120 and second external electrode 130 may each include a plating layer. The plating layer is provided directly on element body portion 110 and directly connected to internal electrode layer 150.

In this case, the plating layer preferably includes a first plating layer and a second plating layer provided on the first plating layer. Preferably, the first plating layer and the second plating layer each include, for example, plating of one kind of metal including Cu, Ni, Sn, Pb, Au, Ag, Pd, Bi, and Zn, or plating of an alloy including this metal.

For example, when Ni is used as the internal electrode, preferably Cu having a good bonding property with Ni is used as the first plating layer. As the second plating layer, for example, preferably Sn or Au having good solder wettability is used and, as the first plating layer, preferably Ni serving as a solder barrier is used.

The second plating layer is provided as required, and the external electrode may include only the first plating layer. The second plating layer may be provided as the outermost layer of the plating layer, or another plating layer may be provided on the second plating layer. Preferably, the plating layer does not include glass.

The ratio of metal per unit volume of the plating layer is, for example, preferably about 99% by volume or more. The plating layer is formed of grains grown in thickness direction T, and may have a columnar shape, for example.

Preferably, the number of a plurality of stacked dielectric layers 140 is 100 or more and 1000 or less, for example. The number of stacked layers also includes the number of outer layers (a first outer layer portion X1 and a second outer layer portion X2) described later herein.

As a material of dielectric layer 140, a dielectric ceramic material including BaTiO₃ or the like as a main component, for example, can be used. The dielectric ceramic material additionally including, for example, a lower-content component than the main component, such as a Mn compound, a Fe compound, a Cr compound, a Co compound, or a Ni compound, may also be used as the material forming dielectric layer 140. The thickness of dielectric layer 140 is, for example, preferably about 0.4 μm or more and about 0.6 μm or less.

The number of a plurality of stacked internal electrode layers 150 is preferably, for example, 10 or more and 1000 or less. The thickness of each internal electrode layer 150 is, for example, preferably about 0.3 μm or more and about 0.7 μm or less. Internal electrode layer 150 is made of one kind of metal including Ni, Cu, Ag, Pd, and Au, or an alloy including this metal, and an alloy of Ag and Pd, for example, can be used. Internal electrode layer 150 may include dielectric particles having the same composition as the ceramic material included in dielectric layer 140.

A plurality of internal electrode layers 150 include a plurality of first internal electrode layers 151 connected to first external electrode 120 and a plurality of second internal electrode layers 152 connected to second external electrode 130.

As shown in FIG. 2, first internal electrode layer 151 includes an opposing portion 151A opposing to second internal electrode layer 152 and a lead-out portion 151B extending to first end surface 115. Second internal electrode layer 152 includes an opposing portion 152A opposing to first internal electrode layer 151 and a lead-out portion 152B extending to second end surface 116. Opposing portions 151A and 152A each correspond to an opposing portion opposing, in thickness direction T, to adjacent internal electrode layer 150.

Each of first internal electrode layer 151 and second internal electrode layer 152 may include, for example, Sn at the interface with dielectric layer 140.

As shown in FIGS. 2 and 3, an inner layer portion C, a first outer layer portion X1, a second outer layer portion X2, a first side margin portion S1, a second side margin portion S2, a first end margin portion E1, and a second end margin portion E2 are defined in element body portion 110.

Inner layer portion C includes opposing portion 151A of first internal electrode layer 151 and opposing portion 152A of second internal electrode layer 152 that are stacked in thickness direction T, and therefore has a capacitance.

First outer layer portion X1 and second outer layer portion X2 sandwich inner layer portion C in thickness direction T. First outer layer portion X1 is located outside inner layer portion C in thickness direction T, and is located on the first principal surface 111 side. Second outer layer portion X2 is located outside inner layer portion C in thickness direction T, and is located on the second principal surface 112 side. Preferably, for example, first outer layer portion X1 and second outer layer portion X2 each have a thickness of about 0.4 μm or more and about 0.6 μm or less.

First end margin portion E1 and second end margin portion E2 sandwich inner layer portion C in length direction L. First end margin portion E1 is located outside inner layer portion C in length direction L, and is located on the first end surface 115 side. Second end margin portion E2 is located outside inner layer portion C in length direction L, and is located on the second end surface 116 side.

For example, each of the dimension in length direction L of first end margin portion E1 and the dimension in length direction L of second end margin portion E2 is preferably about 10 μm or more and about 40 μm or less.

First side margin portion S1 and second side margin portion S2 sandwich inner layer portion C in width direction W. First side margin portion S1 is located outside inner layer portion C in width direction W, and is located on the first side surface 113 side. Second side margin portion S2 is located outside inner layer portion C in width direction W, and is located on the second side surface 114 side.

For example, each of the dimension in width direction W of first side margin portion S1 and the dimension in width direction W of second side margin portion S2 is preferably about 10 μm or more and about 40 μm or less.

Third internal electrode layers 153 are disposed in first side margin portion S1 and second side margin portion S2. Specifically, third internal electrode layer 153 is disposed between each of a plurality of opposing portions 151A and 152A and each of first side surface 113 and second side surface 114, in width direction W. Third internal electrode layer 153 is made of a material substantially identical to that of internal electrode layer 150. Third internal electrode layer 153 may include, for example, Ni.

Third internal electrode layer 153 is provided independently of internal electrode layer 150 and electrically insulated from internal electrode layer 150. Third internal electrode layer 153 is spaced away from internal electrode layer 150. Third internal electrode layer 153 is located at the same or substantially the same position in the thickness direction as the corresponding opposing portion. In the above description, the corresponding opposing portion refers to the opposing portion located side by side in width direction W with respect to third internal electrode layer 153.

The thickness of third internal electrode layer 153 in thickness direction T is smaller than that of internal electrode layer 150. The thickness of third internal electrode layer 153 is approximately one-third or more and approximately one-half or less of the thickness of internal electrode layer 150. If the thickness of third internal electrode layer 153 is larger than about one-half of the thickness of internal electrode layer 150, a structural defect may be generated due to a level difference between internal electrode layer 150 and dielectric layer 140.

Third internal electrode layer 153 have an island shape, a dot shape, or a shape extending in length direction L, for example. Third internal electrode layer 153 may extend continuously or intermittently in length direction L.

The grain size in a peripheral region R3 of third internal electrode layer 153 is smaller than the grain size in the vicinity of the outermost surface of element body portion 110. Peripheral region R3 is, for example, a region within about 30 μm from third internal electrode layer 153. The vicinity of the outermost surface of element body portion 110 is, for example, a region within about 10 μm from first principal surface 111 or second principal surface 112.

As described later, when multilayer ceramic capacitor 100 is manufactured, a multilayer chip that is to form element body portion 110 is sintered. At this time, Ni included in third internal electrode layer 153 diffuses into dielectric layer 140, and therefore, growth of grains included in dielectric layer 140 located in peripheral region R3 of third internal electrode layer 153 can be reduced or prevented.

Preferably, the grain size in peripheral region R3 of third internal electrode layer 153 is, for example, approximately one-fourth or less of the grain size in a portion of dielectric layer 140 that is not affected by Ni. For example, the grain size in peripheral region R3 is about 0.02 μm or more and about 0.1 μm or less.

The grain size is calculated, for example, by measuring the area of each grain using an SEM, in a cross section with thickness direction T and width direction W, of a central portion of multilayer ceramic capacitor 100 in length direction L, and calculating the circle equivalent diameter. Specifically, about 20 grains excluding singular points are randomly measured, and the circle equivalent diameter is calculated from them.

Further, for example, when dielectric layer 140 includes Ni as a subcomponent, Ni is not included in a portion of dielectric layer 140 that is located in the vicinity of third internal electrode layer 153. This is because Ni of dielectric layer 140 is absorbed by third internal electrode layer 153. The vicinity of third internal electrode layer 153 refers to a region extending from third internal electrode layer 153 by approximately one-third of the thickness of third internal electrode layer 153.

In other words, Ni is diffused in a peripheral region of third internal electrode layer 153, the peripheral region excluding a region extending from the third internal electrode layer by one-third of the thickness of the third internal electrode layer. A portion of third internal electrode layer 153, in particular, the outer side in width direction W may be oxidized. Alternatively, the entire or substantially the entire third internal electrode layer 153 may be oxidized.

The presence or absence of Ni can be detected by polishing multilayer ceramic capacitor 100 to expose dielectric layer 140 located around third internal electrode layer 153 and observing the exposed dielectric layer 140 with an EDX.

In first end margin portion E1, lead-out portion 151B of first internal electrode layer 151 and fourth internal electrode layer 154 are disposed. In second end margin portion E2, lead-out portion 152B of second internal electrode layer 152 and fourth internal electrode layer 154 are disposed. Fourth internal electrode layer 154 is made of a material substantially identical to that of internal electrode layer 150. Fourth internal electrode layer 154 may include Ni, for example.

Fourth internal electrode layers 154 are disposed between a plurality of first internal electrode layers 151 and second end surface 116 and between a plurality of second internal electrode layers 152 and first end surface 115, in length direction L.

Fourth internal electrode layer 154 is provided independently of internal electrode layer 150 and electrically insulated from internal electrode layer 150. Fourth internal electrode layer 154 is spaced away from internal electrode layer 150. Fourth internal electrode layer 154 is located at the same or substantially the same position in thickness direction T as corresponding internal electrode layer 150. In the above description, corresponding internal electrode layer 150 refers to internal electrode layer 150 located side by side in length direction L with respect to fourth internal electrode layer 154.

The thickness of fourth internal electrode layer 154 in thickness direction T is smaller than that of internal electrode layer 150. The thickness of fourth internal electrode layer 154 is approximately one-third or more and approximately one-half or less of the thickness of internal electrode layer 150. If the thickness of fourth internal electrode layer 154 is larger than about one-half of the thickness of internal electrode layer 150, a structural defect may be generated due to a level difference between internal electrode layer 150 and dielectric layer 140.

Fourth internal electrode layer 154 have an island shape, a dot shape, or a shape extending in width direction W. Fourth internal electrode layer 154 may extend continuously or intermittently in width direction W.

The grain size in a peripheral region R4 of fourth internal electrode layer 154 is smaller than the grain size in the vicinity of the outermost surface of element body portion 110. Peripheral region R4 is, for example, a region within about 30 μm from fourth internal electrode layer 154. The vicinity of the outermost surface of element body portion 110 is, for example, a region within about 10 μm from first principal surface 111.

As described later, when multilayer ceramic capacitor 100 is manufactured, a multilayer chip that is to form element body portion 110 is sintered. At this time, Ni included in fourth internal electrode layer 154 diffuses into dielectric layer 140, and therefore, growth of grains included in dielectric layer 140 located in peripheral region R4 of fourth internal electrode layer 154 can be reduced or prevented.

Preferably, the grain size in peripheral region R4 of fourth internal electrode layer 154 is, for example, approximately one-fourth or less of the grain size in a portion of dielectric layer 140 that is not affected by Ni. For example, the grain size in peripheral region R4 is about 0.02 μm or more and about 0.1 μm or less.

The grain size is calculated, for example, by measuring the area of the grain using an SEM, in a cross section having thickness direction T and length direction L, of a central portion of multilayer ceramic capacitor 100 in width direction W, and calculating the circle equivalent diameter. Specifically, about 20 grains excluding singular points are randomly measured, and the circle equivalent diameter is calculated from them.

Further, when dielectric layer 140 includes, for example, Ni as a subcomponent, Ni is not included in a portion of dielectric layer 140 that is located in the vicinity of fourth internal electrode layer 154. This is because Ni of dielectric layer 140 is absorbed by fourth internal electrode layer 154. The vicinity of fourth internal electrode layer 154 refers to a region extending from fourth internal electrode layer 154 by approximately one-third of the thickness of fourth internal electrode layer 154. A portion of fourth internal electrode layer 154, in particular, the outer side in width direction W may be oxidized. Alternatively, the entire or substantially the entire fourth internal electrode layer 154 may be oxidized.

In other words, Ni is diffused in a peripheral region of fourth internal electrode layer 154, the peripheral region excluding a region extending from the fourth internal electrode layer by about one-third of the thickness of fourth internal electrode layer 154.

The presence or absence of Ni can be detected by polishing multilayer ceramic capacitor 100 to expose dielectric layer 140 located around fourth internal electrode layer 154 and observing the exposed dielectric layer 140 with an EDX.

As described above, in multilayer ceramic capacitor 100 according to the present example embodiment, third internal electrode layers 153 are disposed in first side margin portion S1 and second side margin portion S2, and fourth internal electrode layers 154 are disposed in first end margin portion E1 and second end margin portion E2.

Thus, even when moisture enters into the interior of element body portion 110 from any of first side margin portion S1, second side margin portion S2, first end margin portion E1, and second end margin portion E2, the moisture can be prevented from entering further into the interior of element body portion 110 by third internal electrode layer 153 and/or fourth internal electrode layer 154.

In addition, when third internal electrode layer 153 and fourth internal electrode layer 154 include Ni, it is possible to reduce or prevent growth of grains included in dielectric layer 140 located in peripheral region R3 of third internal electrode layer 153 and peripheral region R4 of fourth internal electrode layer 154, and therefore, it is possible to increase the interfaces of grains. As a result, the moisture resistance reliability can further be improved.

While the foregoing illustrates the case where a plurality of third internal electrode layers 153 are provided for respective opposing portions of a plurality of internal electrode layers 150, example embodiments of the present invention are not limited to this. Third internal electrode layer 153 may be provided in a space between at least one of a plurality of opposing portions and at least one of first side surface 113 and second side surface 114. For example, third internal electrode layer 153 may be provided for every other layer. Moreover, third internal electrode layer 153 may be provided only in first side margin portion S1 or may be provided only in second side margin portion S2. In this case as well, the moisture resistance of multilayer ceramic capacitor 100 can be improved at least on one side in width direction W.

Similarly, while the foregoing illustrates the case where a plurality of fourth internal electrode layers 154 are provided for respective internal electrode layers 150, example embodiments of the present invention are not limited to this. Fourth internal electrode layers 154 may be provided between at least one of a plurality of first internal electrode layers 151 and second end surface 116, and between at least one of a plurality of second internal electrode layers 152 and first end surface 115, in length direction L. For example, fourth internal electrode layer 154 may be provided for every other layer. Fourth internal electrode layer 154 may be provided only in first end margin portion E1 or may be provided only in second end margin portion E2. In this case as well, the moisture resistance of multilayer ceramic capacitor 100 can be improved at least on one side in length direction L.

### Method for Manufacturing Multilayer Ceramic Capacitor

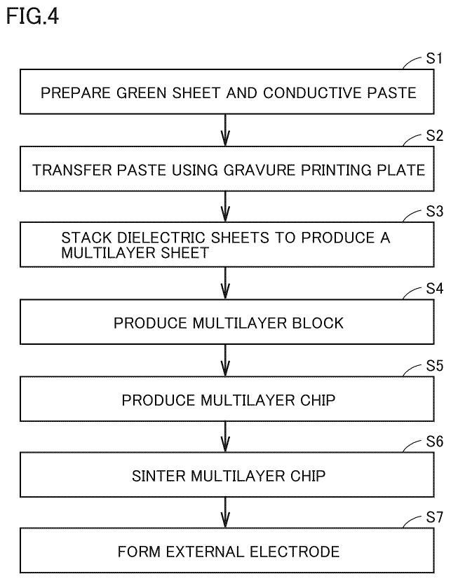

FIG. 4 is an example of a flowchart showing a manufacturing flow for manufacturing a multilayer ceramic capacitor according to an example embodiment of the present invention. An example of a method for manufacturing a multilayer ceramic capacitor according to an example embodiment is now described with reference to FIG. 4.

As shown in FIG. 4, for manufacturing a multilayer ceramic capacitor as a multilayer electronic component, initially a green sheet to form dielectric layer 140 and a conductive paste for internal electrode layer 150 are prepared in a step (S1). The green sheet is formed from a dielectric paste obtained by kneading ceramic powder which is typically barium titanate, a binder, a dispersant and a plasticizer, for example. The conductive paste is obtained by kneading conductive powder, a solvent, a binder, and ceramic powder, for example. As the green sheet and the conductive paste, a known green sheet and a known conductive paste can be used, respectively.

Subsequently, in a step (S2), the conductive paste for the internal electrode is transferred onto the green sheet in a predetermined pattern, using a gravure printing plate, for example. Thus, a dielectric sheet is formed on which an electrode pattern to form internal electrode layer 150 is formed. A pattern that is to form an internal electrode pattern is formed on the peripheral surface of the gravure printing plate, and a pattern having a depth shallower than that of the pattern is formed in a region outside the pattern. The conductive paste transferred from the shallow pattern forms third internal electrode layer 153 and fourth internal electrode layer 154.

Subsequently, in a step (S3), a plurality of dielectric sheets are stacked to produce a multilayer sheet. Specifically, a predetermined number of dielectric sheets for an outer layer on which no electrode pattern is printed are stacked, dielectric sheets on which the electrode pattern is printed are sequentially stacked thereon, and a predetermined number of the dielectric sheets for the outer layer are stacked thereon.

Subsequently, in a step (S4), a multilayer block is produced. Specifically, the multilayer sheet is pressed in the stacking direction using a press device such as an isostatic press, for example.

Subsequently, in a step (S5), a multilayer chip is produced. Specifically, the multilayer block is cut into a multilayer chip having a predetermined size, using a cutting blade, for example. At this time, corners and ridges of the multilayer chip may be rounded by, for example, barrel polishing or the like.

Subsequently, in a step (S6), the multilayer chip is sintered. The sintering temperature is about 900° C. to about 1300° C., for example, which, however, depends on the materials for the dielectric and the electrode pattern.

Subsequently, in a step (S7), an external electrode is formed. For example, a conductive paste for an external electrode is applied to both end surfaces of the multilayer chip and baked to form baked layers on these end surfaces. At this time, the baking temperature is, for example, about 700° C. to about 900° C. Subsequently, a plating layer is provided on the surface of the baked layer as required. Through the above-described steps, the multilayer electronic component can be manufactured. When the external electrode is formed, a plating layer may be formed directly on element body portion 110, without forming the baked layer. Through these steps, multilayer ceramic capacitor 100 according to the present example embodiment can be manufactured.

### OTHER MODIFICATIONS

While the forgoing description of example embodiments illustrates, by way of example, the case where both third internal electrode layer 153 and fourth internal electrode layer 154 are provided, example embodiments of the present invention are not limited to this. At least one of third internal electrode layer 153 and fourth internal electrode layer 154 may be provided.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an element body portion including a first principal surface and a second principal surface opposite to each other in a thickness direction, a first side surface and a second side surface opposite to each other in a width direction, and a first end surface and a second end surface opposite to each other in a length direction, and including a plurality of dielectric layers and a plurality of internal electrode layers stacked in the thickness direction;
a first external electrode on the first end surface; and
a second external electrode on the second end surface; wherein
the plurality of internal electrode layers include a plurality of first internal electrode layers connected to the first external electrode, and a plurality of second internal electrode layers connected to the second external electrode;
each of the plurality of internal electrode layers includes an opposing portion opposed, in the thickness direction, to an adjacent internal electrode layer of the plurality of internal electrode layers; and
a third internal electrode layer is located in a space between the opposing portion and at least one of the first side surface and the second side surface, in the width direction.

2. The multilayer ceramic capacitor according to claim 1, wherein a fourth internal electrode layer is located in at least one of a space between the first internal electrode layer and the second end surface, and a space between the second internal electrode layer and the first end surface, in the length direction.

3. The multilayer ceramic capacitor according to claim 2, wherein
the fourth internal electrode layer located in the space between the first internal electrode layer and the second end surface in the length direction is located at a same or substantially a same position in the thickness direction as the first internal electrode layer; and
the third internal electrode layer located in the space between the second internal electrode layer and the first end surface in the length direction is located at a same or substantially a same position in the thickness direction as the second internal electrode layer.

4. The multilayer ceramic capacitor according to claim 2, wherein Ni is diffused in a peripheral region of the fourth internal electrode layer, the peripheral region excluding a region extending from the fourth internal electrode layer by about one-third of a thickness of the fourth internal electrode layer.

5. The multilayer ceramic capacitor according to claim 2, wherein a grain size in a peripheral region of the fourth internal electrode layer is smaller than a grain size in a vicinity of an outermost surface of the element body portion.

6. The multilayer ceramic capacitor according to claim 1, wherein Ni is diffused in a peripheral region of the third internal electrode layer, the peripheral region excluding a region extending from the third internal electrode layer by about one-third of a thickness of the third internal electrode layer.

7. The multilayer ceramic capacitor according to claim 1, wherein the third internal electrode layer is located at a same or substantially a same position in the thickness direction as the opposing portion.

8. The multilayer ceramic capacitor according to claim 1, wherein a grain size in a peripheral region of the third internal electrode layer is smaller than a grain size in a vicinity of an outermost surface of the element body portion.

9. The multilayer ceramic capacitor according to claim 1, wherein each of the first and second external electrodes includes a base electrode layer and a plating layer on the base electrode layer.

10. The multilayer ceramic capacitor according to claim 9, wherein the base electrode layer includes a baked layer including glass and metal.

11. The multilayer ceramic capacitor according to claim 10, wherein the glass includes Si.

12. The multilayer ceramic capacitor according to claim 10, wherein the metal includes Ni, Cu, Ag, Pd, or Au, or an alloy including at least one of Ni, Cu, Ag, Pd, or Au.

13. A multilayer ceramic capacitor comprising:
an element body portion including a first principal surface and a second principal surface opposite to each other in a thickness direction, a first side surface and a second side surface opposite to each other in a width direction, and a first end surface and a second end surface opposite to each other in a length direction, and including a plurality of dielectric layers and a plurality of internal electrode layers stacked in the thickness direction;
a first external electrode on the first end surface; and
a second external electrode on the second end surface; wherein
the plurality of internal electrode layers include a plurality of first internal electrode layers connected to the first external electrode, and a plurality of second internal electrode layers connected to the second external electrode; and
a fourth internal electrode layer is located in at least one of a space between the first internal electrode layer and the second end surface, and a space between the second internal electrode layer and the first end surface, in the length direction.

14. The multilayer ceramic capacitor according to claim 13, wherein the fourth internal electrode layer located in the space between the first internal electrode layer and the second end surface in the length direction is located at a same or substantially a same position in the thickness direction as the first internal electrode layer.

15. The multilayer ceramic capacitor according to claim 13, wherein Ni is diffused in a peripheral region of the fourth internal electrode layer, the peripheral region excluding a region extending from the fourth internal electrode layer by about one-third of a thickness of the fourth internal electrode layer.

16. The multilayer ceramic capacitor according to claim 13, wherein a grain size in a peripheral region of the fourth internal electrode layer is smaller than a grain size in a vicinity of an outermost surface of the element body portion.

17. The multilayer ceramic capacitor according to claim 13, wherein each of the first and second external electrodes includes a base electrode layer and a plating layer on the base electrode layer.

18. The multilayer ceramic capacitor according to claim 17, wherein the base electrode layer includes a baked layer including glass and metal.

19. The multilayer ceramic capacitor according to claim 18, wherein the glass includes Si.

20. The multilayer ceramic capacitor according to claim 18, wherein the metal includes Ni, Cu, Ag, Pd, or Au, or an alloy including at least one of Ni, Cu, Ag, Pd, or Au.
